(19) United States
(12) Patent Application Publication
(10) Pub. No.: US 2025/0198549 A1
(43) Pub. Date: Jun. 19, 2025

(54) COUPLING DEVICE FOR CONNECTION OF A MICROCHANNEL TUBE

(71) Applicant: ETI, LLC, Geneva, IN (US)

(72) Inventor: Troy Lynn Kirchhofer, Berne, IN (US)

(21) Appl. No.: 18/937,926

(22) Filed: Nov. 5, 2024

Related U.S. Application Data
(60) Provisional application No. 63/611,507, filed on Dec. 18, 2023.

(51) Int. Cl. F16L 13/08

(52) U.S. Cl. CPC F16L 13/08

(57) ABSTRACT

Kits, devices, and methods of manufacture include an elongate body including a first longitudinal end and a second longitudinal end opposite the first longitudinal end, where at least one end of the first longitudinal end and the second longitudinal end includes a flange fitting longitudinally extending therefrom. Further, an elongated socket is disposed in a sidewall of the elongate body, where the elongated socket is configured to operatively connect to a microchannel tube that includes an alloy material forming a first planar surface and a second planar surface opposite the first planar surface with a plurality of partitions disposed between the first planar surface and the second planar surface, where the plurality of partitions form microchannels through which a heat transfer medium can flow in a laminar manner.

### CROSS-REFERENCE TO RELATED APPLICATIONS

This application claims priority to and benefit of U.S. Provisional Patent Application No. 63/611,507 filed on Dec. 18, 2023, entitled COUPLING DEVICE FOR CONNECTION OF A MICROCHANNEL TUBE, the present application is also related to U.S. Pat. No. 9,995,392 B2 issued on Jun. 12, 2018, entitled “Method of Manufacturing Unitary Hollow Pistons,” the entire contents of both of which are expressly incorporated by reference in their entireties.

### TECHNICAL FIELD

One or more aspects of the present disclosure broadly relates to coupling devices, and more particularly to a coupling devices for the connection of a microchannel tube.

### BACKGROUND

High pressure condenser coils utilized by the heating, ventilation, and air conditioning industry (HVAC) industry often cast or forge components in ways that incorporate porosity that disrupt the grain structure of the alloy. As new technologies develop for various heat exchange technologies, new needs arise for providing better flow of a heat transfer medium. In recent years, microchannel technology has been utilized in the commercial air conditioning industry that are often favored in the industry due, at least in part, to superior mechanical resistance, improved reliability assembly and corrosion resistance. Thus, a need arises to provide improved implementation and incorporation of the microchannel technology into various HVAC systems.

### SUMMARY

Shortcomings of the prior art are overcome and additional advantages are provided through the provision of a coupling kit that includes a coupling device and a microchannel tube. The coupling device includes an elongate body including a first longitudinal end and a second longitudinal end opposite the first longitudinal end, wherein at least one end of the first longitudinal end and the second longitudinal end comprises a flange fitting longitudinally extending therefrom. Further, the coupling device includes an elongated socket disposed in a sidewall of the elongate body, the elongated socket being configured to operatively connect to a microchannel tube. The microchannel tube is configured to be operatively connected to the elongated socket of the coupling device. The microchannel tube includes an alloy material forming a first planar surface and a second planar surface opposite the first planar surface, wherein a plurality of partitions are disposed between the first planar surface and the second planar surface, the plurality of partitions forming microchannels through which a heat transfer medium can flow in a laminar manner.

Further, a coupling device is disclosed that includes an elongate body including a first longitudinal end and a second longitudinal end opposite the first longitudinal end, where at least one end of the first longitudinal end and the second longitudinal end includes a flange fitting longitudinally extending therefrom. In addition, an elongated socket is disposed in a sidewall of the elongate body, the elongated socket being configured to operatively connect to a microchannel tube.

A method of manufacturing a coupling device is also disclosed. The method includes inserting clad material and base material into a die, and operating the die to form the coupling device from the clad material and the base material. The operating includes closing two or more parts of the die to form the coupling device, where the operating includes integrally coating the clad material on at least one portion of a surface of the coupling device as the coupling device is formed. The coupling device includes an elongate body including a first longitudinal end and a second longitudinal end opposite the first longitudinal end, where at least one end of the first longitudinal end and the second longitudinal end includes a flange fitting longitudinally extending therefrom. Also, the coupling device includes an elongated socket is disposed in a sidewall of the elongate body, the elongated socket being configured to operatively connect to a microchannel tube. The method also includes forming the base material into a blank corresponding to the coupling device.

Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts a top front perspective view of an example coupling device, according to one embodiment;

FIG. 2 depicts a top back perspective view of the example coupling device of FIG. 1, according to one embodiment;

FIG. 3 depicts a bottom back perspective view of the example coupling device of FIGS. 1-2, according to one embodiment;

FIG. 4 depicts a bottom front perspective view of the example coupling device of FIGS. 1-3, according to one embodiment;

FIG. 5 depicts a back view of the example coupling device of FIGS. 1-4, according to one embodiment;

FIG. 6 depicts a front view of the example coupling device of FIGS. 1-5, according to one embodiment;

FIG. 7 depicts a top view of the example coupling device of FIGS. 1-6, according to one embodiment;

FIG. 8 depicts a bottom view of the example coupling device of FIGS. 1-7, according to one embodiment;

FIG. 9 depicts a cross-sectional perspective view of the example coupling device of FIGS. 1-8, according to one embodiment;

FIG. 10A depicts a perspective view of a kit that includes the example coupling device of FIGS. 1-9 and a microchannel tube, according to one embodiment;

FIG. 10B depicts a perspective view of a kit that includes the example coupling device of FIGS. 1-10 operatively connected to the microchannel tube of FIG. 10A, according to one embodiment; and

FIG. 11 depicts a block diagram of an example method of manufacture, according to one embodiment.

### DETAILED DESCRIPTION

The following detailed description and appended drawings describe and illustrate various exemplary embodiments of the disclosure. The description and drawings serve to enable one skilled in the art to make and use the disclosure, and are not intended to limit the scope of the disclosure in any manner. In respect of the methods disclosed, the steps presented are exemplary in nature, and thus, the order of the steps is not necessary or critical.

“A” and “an” as used herein indicate “at least one” of the item is present; a plurality of such items may be present, when possible. Spatially relative terms, such as “front,” “back,” “inner,” “outer,” “bottom,” “top,” “horizontal,” “vertical,” “upper,” “lower,” “side,” “above,” “below,” “beneath,” “upwardly,” “outwardly,” “inwardly,” and the like, may be used herein for case of description to describe one element or feature's relationship to another element(s) or feature(s) as illustrated in the figures. Spatially relative terms may be intended to encompass different orientations of the device in use or operation in addition to the orientation depicted in the figures.

It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

As used herein, substantially is defined as “to a considerable degree” or “proximate” or as otherwise understood by one ordinarily skilled in the art or as otherwise noted. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

The terms “couple”, “coupled”, “couples”, “coupling”, “fixed”, “attached to”, “connect”, “connected”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

Where any conflict or ambiguity may exist between a document incorporated by reference and this detailed description, the present detailed description controls. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context.

Aspects of the present invention are described herein with reference to flowchart illustrations and/or block diagrams of methods, according to embodiments of the invention. It will be understood that each block of the flowchart illustrations and/or block diagrams, and combinations of blocks in the flowchart illustrations and/or block diagrams, can represent a module, segment, or portion of a process. In some alternative implementations, the process noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved.

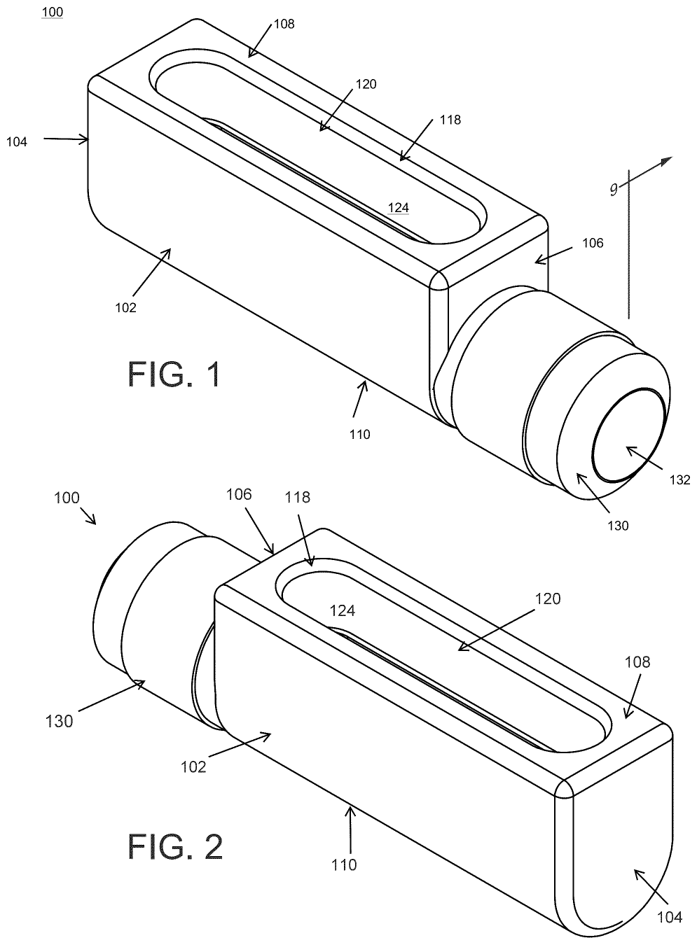

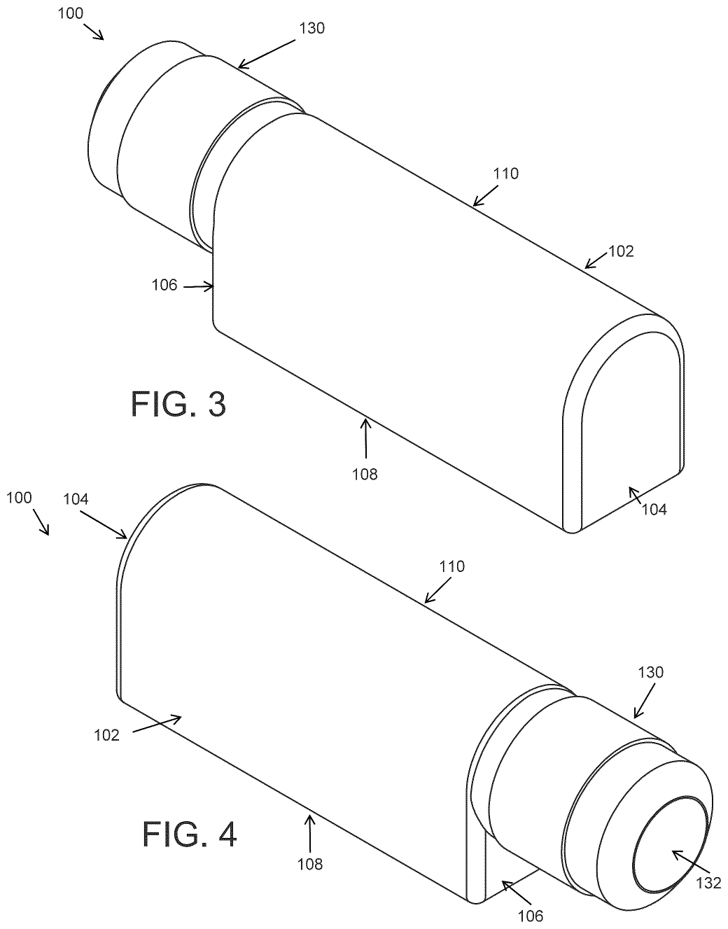

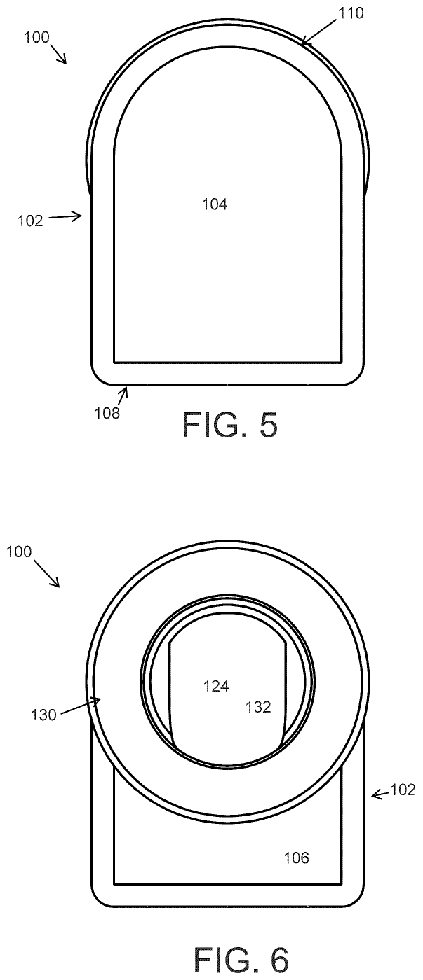

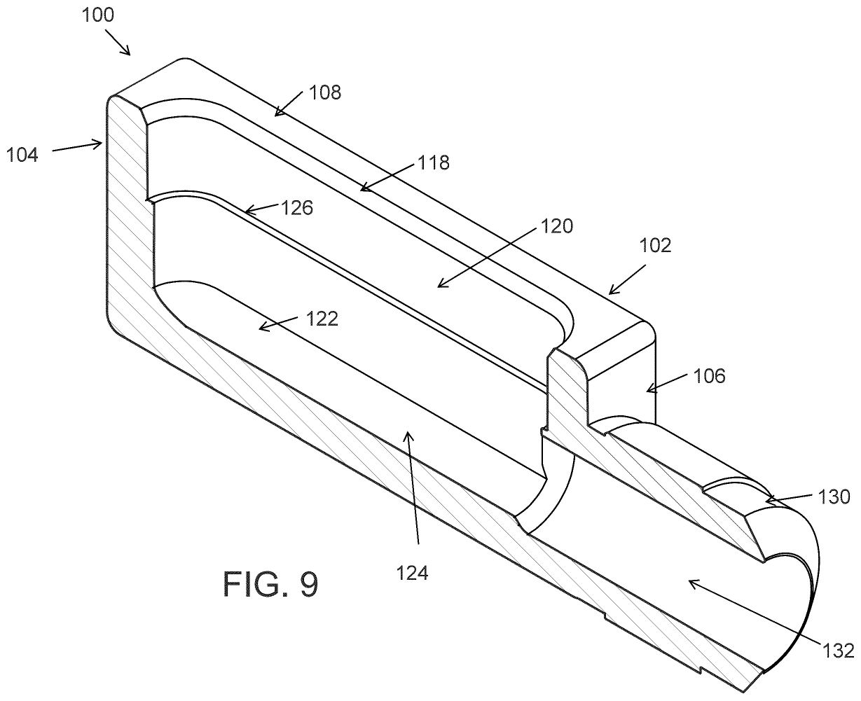

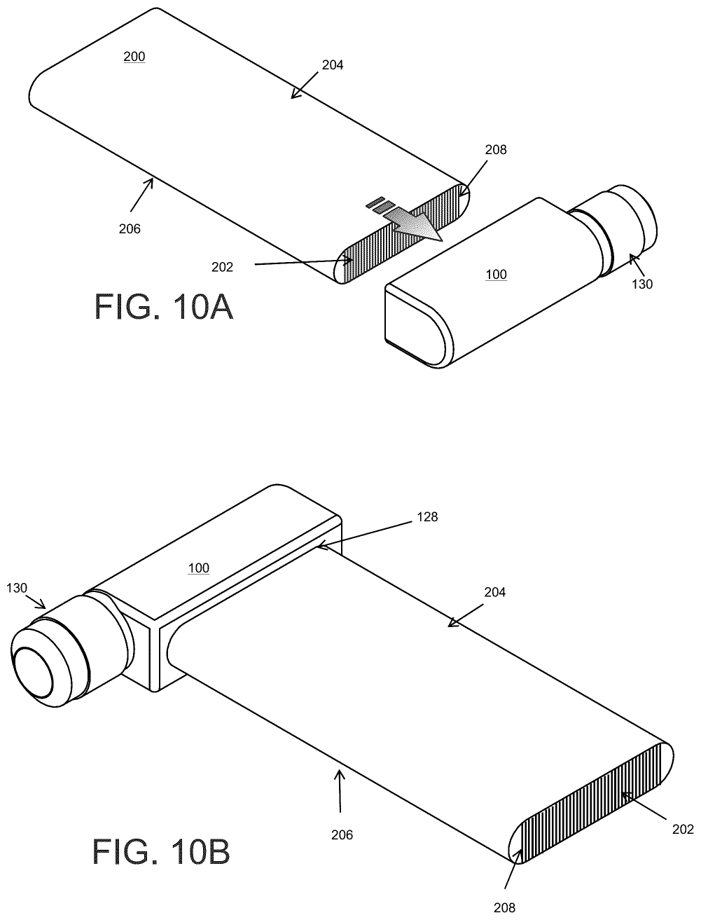

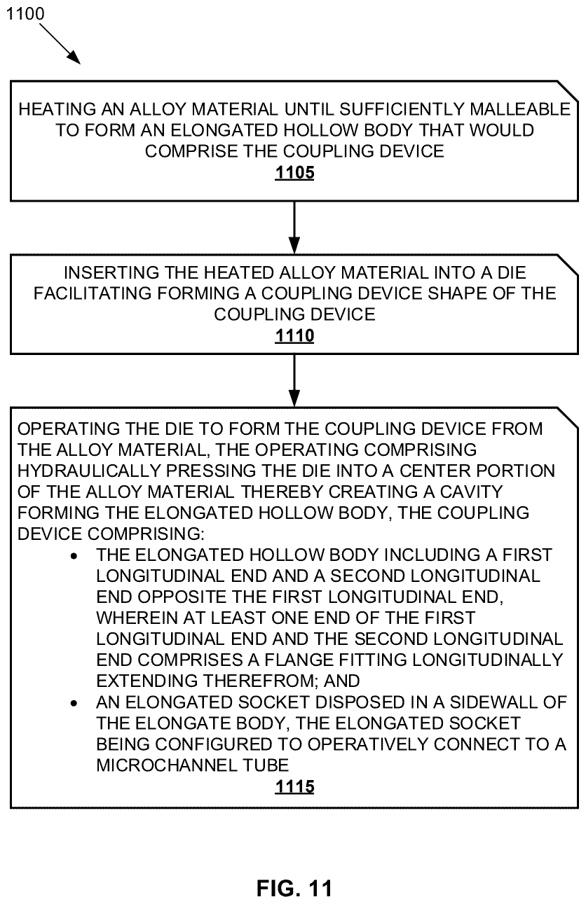

FIGS. 1-9 depict various views of a coupling device 100. FIGS. 10A and 10B depict a kit that includes the coupling device 100 depicted in FIGS. 1-9. FIG. 11 depicts an example method of manufacture to make the coupling device 100 depicted by FIGS. 1-11. The process used to manufacture the coupling device 100 is partially described by U.S. Pat. No. 9,995,392 B2 issued on Jun. 12, 2018 entitled “Method for Manufacturing Unitary Hollow Pistons,” that neither casts the coupling device 100 nor forges the coupling device 100. The method of manufacture incorporates a semi-solid state of an alloy by heating it to near the alloy's molten state and then squeeze forming the alloy using high hydraulic pressure of (up to 1,000 tons of hydraulic pressure) to form the alloy into a new shape. Advantageously, the method of manufacture described herein significantly reduces porosity, or even eliminates porosity, and maintains the grain structure of the alloy when it is heated to a semi-solid state and then pressed into the desired shape. This method of manufacture enhances the coupling device's 100 ability to handle high levels of pressure (e.g., 2,000 pounds of pressure). The method of manufacture provides an enhanced connection with a microchannel tube 200, such as that depicted in FIGS. 10A and 10B. The coupling device 100 provides a connection, via a flange fitting 130, to HVAC tubes that are more standard for many compressors as well as to the microchannel tube 200.

In some embodiments, the flange fitting 130 may comprise threads that form a threaded connection, such as a joint industry council (JIC) fittings that includes a 37 degree flare seating surface and threads that is commonly used in high pressure applications within the HVAC industry for hydraulic-type fittings. In some embodiments, the threaded connection of the flange fitting 130 forms a threaded exterior surface (i.e., a male connection), whereas in other embodiments the threaded connection of the flange fitting 130 may include a threaded interior hollow core (i.e., a female connection). Alternatively, in other embodiments, a straight can be used that facilitates brazing a tube to the flange fitting 130 thereby forming a braze joint between the coupling device 100 and a HVAC tube (not shown). The coupling device 100 also includes an elongated socket 120 that can facilitate brazing the microchannel tube 200 to the coupling device 100. The braze joint 128 formed by the braze joint configuration of the elongated socket 120 and formed between the elongated socket 120 and the microchannel tube 200, as depicted by FIG. 10B, may be configured to hold or otherwise retain connectivity when a pressure of at least 2,000 pounds per square inch (psi) is applied.

Various microchannel sizes of the microchannels 202 may be utilized in the microchannel tube 200, so the size and shape of the elongated socket 120 may vary depending upon the manufacturer of the microchannel tube 200. In some embodiments, the elongated socket 120 includes a stadium-shaped or pill-shaped opening that extends longitudinally from proximate the first longitudinal end to the second longitudinal end. In other embodiments, the elongated socket 120 may be rectangular, spherical, triangular, hexagonal, polygonal, circular, oblong, square, and/or otherwise sized, shaped, and configured to receive the microchannel tube 200.

Referring now to FIGS. 1-10B, disclosed herein is a coupling device 100 that includes an elongate body 102 that includes a first longitudinal end 104 and a second longitudinal end 106 opposite the first longitudinal end 104. At least one end, either the first longitudinal end 104 or the second longitudinal end 106, includes a flange fitting 130 longitudinally extending from the one end. The coupling device 100 also includes an elongated socket 120 disposed in a sidewall 108 of the elongate body 102. The elongate body 102 is configured to operatively connect to a microchannel tube 200 (see FIGS. 10A-10B). The microchannel tube 200 (see FIGS. 10A-10B) may be configured to operatively connect to the elongated socket 120 of the coupling device 100. In some embodiments, the microchannel tube 200 includes an alloy material forming a first planar surface 204 and a second planar surface 206 opposite the first planar surface 204, where a plurality of partitions 208 are disposed between the first planar surface 204 and the second planar surface 206. The plurality of partitions 208 form microchannels 202 through which a heat transfer medium can flow in a laminar manner.

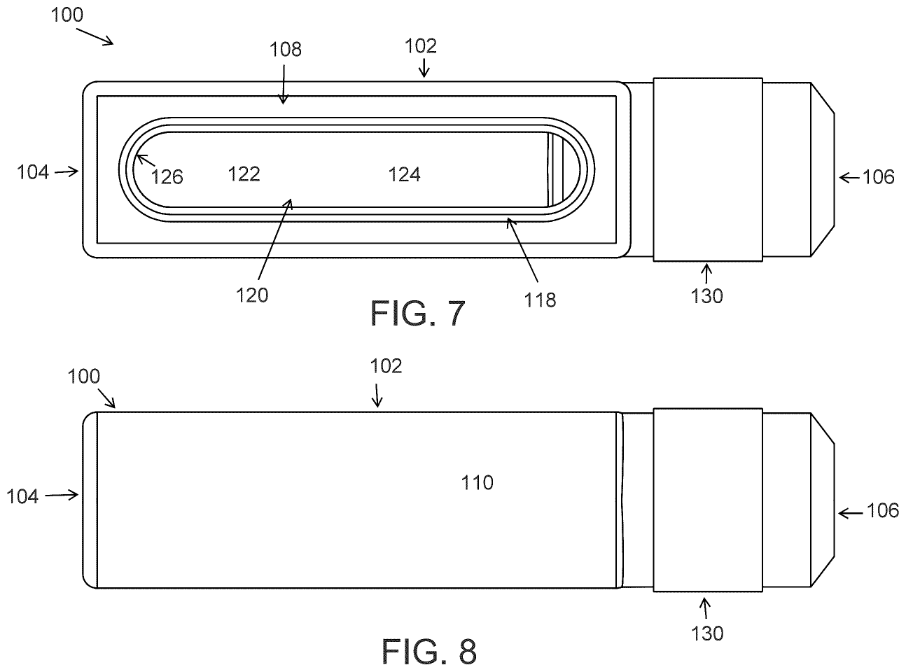

The elongated socket 120 that is formed by an opening 118 may include a contiguous hollow channel 124 connecting the opening to a hollow core 132 of the flange fitting 130. The contiguous hollow channel 124 may be formed by hydraulically pressing a die into the alloy during manufacture in order to fit the size and shape of the microchannel tube 200 and still provide a channel for a heat transfer medium (e.g., air, a liquid, gas, etc.) to pass through the microchannels 202 into the hollow channel 124. For example, a lip surface 126 (see FIG. 9) may be formed on the surface of the hollow channel 124. The lip surface 126 may form a stepwise diameter or stepwise surface such that the lip surface 126 may impede insertion of the microchannel tube further within the hollow channel 124 so that a heat transfer medium is able to flow through the hollow channel 124 without being blocked by a back wall surface 122 (see FIGS. 7 and 9) of the hollow channel 124. In some embodiments, the diameter of the hollow channel 124 may gradually taper, rather than having a lip, such that the microchannel tube 200 is only able to traverse a portion of the depth or width of the hollow channel 124. Thus, the microchannel tube 200 is inhibited from traversing the full width of the hollow channel 124 from the opening 118 to the back wall surface 122. Further, in some embodiments, a braze joint 128 may assist in positioning the microchannel tube 200 within the contiguous hollow channel 124. In some embodiments, the contiguous hollow channel 124 includes a capsule-shaped interior, whereas in other embodiments, the contiguous hollow channel 124 may include a rectangular, spherical, triangular, hexagonal, polygonal, circular, oblong, square, and/or otherwise sized, shaped, and configured interior shape.

In some embodiments, the elongate body 102 includes a rectangular dome shape extending from the first longitudinal end 104 to the second longitudinal end 106. In particular, the sidewall 108 may form a rectangular base opposite a dome surface 110 of the rectangular dome shape.

FIG. 11 depicts an example method of manufacture 1100 that includes, at block 1105, heating an alloy material until sufficiently malleable to form an elongated hollow body that would comprise the coupling device. At block 1110, the heated alloy material is inserted into a die facilitating forming a coupling device shape of the coupling device. At block 1115, the die is operated to form the coupling device from the alloy material, the operating comprising hydraulically pressing the die into a center portion of the alloy material thereby creating a cavity forming the elongated hollow body. The coupling device includes an elongated hollow body having a first longitudinal end and a second longitudinal end opposite the first longitudinal end. At least one end of the first longitudinal end and the second longitudinal end includes a flange fitting longitudinally extending therefrom, and an elongated socket is disposed in a sidewall of the elongate body, where the elongated socket is configured to operatively connect to a microchannel tube. The method can incorporate aspects described by U.S. Pat. No. 9,995,392 B2 issued on Jun. 12, 2018.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiments disclosed herein were chosen and described in order to best explain various aspects and the practical application, and to enable others of ordinary skill in the art to understand various embodiments with various modifications suited to the particular use contemplated.

What is claimed is:

1. A coupling kit, comprising:
a coupling device comprising:
an elongate body including a first longitudinal end and a second longitudinal end opposite the first longitudinal end, wherein at least one end of the first longitudinal end and the second longitudinal end comprises a flange fitting longitudinally extending therefrom; and
an elongated socket disposed in a sidewall of the elongate body, the elongated socket being configured to operatively connect to a microchannel tube; and
the microchannel tube configured to be operatively connected to the elongated socket of the coupling device, wherein the microchannel tube comprises an alloy material forming a first planar surface and a second planar surface opposite the first planar surface, wherein a plurality of partitions are disposed between the first planar surface and the second planar surface, the plurality of partitions forming microchannels through which a heat transfer medium can flow in a laminar manner.

2. The coupling kit of claim 1, wherein the elongated socket comprises a stadium-shaped opening that extends longitudinally from proximate the first longitudinal end to the second longitudinal end.

3. The coupling kit of claim 2, wherein the elongated socket comprises a contiguous hollow channel connecting the stadium-shaped opening to a hollow core of the flange fitting.

4. The coupling kit of claim 3, wherein the contiguous hollow channel comprises a capsule-shaped interior.

5. The coupling kit of claim 3, wherein the contiguous hollow channel comprises a lip surface that forms a stepwise diameter within the contiguous channel such that the microchannel tube is inhibited from traversing from the stadium-shaped opening to a back wall surface of the contiguous channel when inserted due to the lip forming a smaller diameter across a back portion of the contiguous channel that is opposite the stadium-shaped opening.

6. The coupling kit of claim 1, wherein the elongate body comprises a rectangular dome extending from the first longitudinal end to the second longitudinal end, wherein the sidewall forms a rectangular base opposite a dome surface of the rectangular dome.

7. The coupling kit of claim 1, wherein the flange fitting comprises a threaded exterior surface.

8. The coupling kit of claim 1, wherein the flange fitting comprises a threaded interior hollow core.

9. The coupling kit of claim 1, wherein the flange fitting comprises a braze joint fitting configuration.

10. The coupling kit of claim 1, wherein the flange fitting comprises a joint industry council fittings comprising a 37 degree flare seating surface and threads.

11. The coupling kit of claim 1, wherein the elongated socket comprises a braze joint configuration such that when the microchannel tube is operatively connected to the elongated socket the braze joint retains connectivity for pressures of at least 2,000 pounds per square inch.

12. A coupling device, comprising:
an elongate body including a first longitudinal end and a second longitudinal end opposite the first longitudinal end, wherein at least one end of the first longitudinal end and the second longitudinal end comprises a flange fitting longitudinally extending therefrom; and
an elongated socket disposed in a sidewall of the elongate body, the elongated socket being configured to operatively connect to a microchannel tube.

13. The coupling device of claim 12, wherein the elongated socket comprises a stadium-shaped opening that extends longitudinally from proximate the first longitudinal end to the second longitudinal end.

14. The coupling device of claim 13, wherein the elongated socket comprises a contiguous channel connecting the stadium-shaped opening to a hollow core of the flange fitting.

15. The coupling device of claim 14, wherein the contiguous channel comprises a hollow capsule-shaped interior.

16. The coupling device of claim 14, wherein the contiguous channel comprises a lip that forms a step-wise diameter within the contiguous channel such that the microchannel tube is inhibited from traversing from the stadium-shaped opening to a back wall of the contiguous channel when inserted due to the lip forming a smaller diameter across a back portion of the contiguous channel that is opposite the stadium-shaped opening.

17. The coupling device of claim 12, wherein the elongate body comprises a rectangular dome extending from the first longitudinal end to the second longitudinal end, wherein the sidewall forms a rectangular base opposite a dome surface of the rectangular dome.

18. The coupling device of claim 12, wherein the flange fitting comprises a threaded exterior surface.

19. The coupling device of claim 12, wherein the flange fitting comprises a threaded interior hollow core.

20. A method of manufacturing a coupling device, comprising:
heating an alloy material until sufficiently malleable to form an elongated hollow body that would comprise the coupling device;
inserting the heated alloy material into a die facilitating forming a coupling device shape of the coupling device; and
operating the die to form the coupling device from the alloy material, the operating comprising hydraulically pressing the die into a center portion of the alloy material thereby creating a cavity forming the elongated hollow body, wherein the coupling device comprises:
the elongated hollow body including a first longitudinal end and a second longitudinal end opposite the first longitudinal end, wherein at least one end of the first longitudinal end and the second longitudinal end comprises a flange fitting longitudinally extending therefrom; and
an elongated socket disposed in a sidewall of the elongate body, the elongated socket being configured to operatively connect to a microchannel tube.
